(19) United States
(12) Patent Application Publication
(10) Pub. No.: US 2004/0191112 A1
(43) Pub. Date: Sep. 30, 2004

(54) Hydrogen peroxide injection system having closed-loop flow control

(75) Inventors: Aaron L. Hill, Erie, PA (US); Leslie M. Logue, Edinboro, PA (US); Terrence L. Lukas, Erie, PA (US)

Correspondence Address: KUSNER & JAFFE, HIGHLAND PLACE SUITE 310, 6151 WILSON MILLS ROAD, HIGHLAND HEIGHTS, OH, 44143, US

(73) Assignee: STERIS Inc.

(21) Appl. No.: 10/403,214

(22) Filed: Mar. 31, 2003

(51) Int. Cl. G05B 1/00; G05D 1/00

(52) U.S. Cl. 422/3; 422/105; 422/108; 422/110; 422/111

(57) ABSTRACT

A system for injecting liquid hydrogen peroxide using a closed-loop flow control for controlling the injection rate of the liquid hydrogen peroxide. An injection rate is determined from measuring the rotational speed of a pump motor. If the determined injection rate varies from the desired injection rate, the speed of the pump motor is modified. Pulse width modulation (PWM) is used to control the pump motor speed.

### FIELD OF THE INVENTION

The present invention generally relates to a flow control system, and more particularly to a system for metering the flow of liquid hydrogen peroxide in a vapor hydrogen peroxide decontamination system, which system has a closed-loop flow control.

### BACKGROUND OF THE INVENTION

Hydrogen peroxide injection systems are used in decontamination systems to deliver a supply of liquid hydrogen peroxide to a vaporization chamber, wherein the liquid hydrogen peroxide is vaporized. The vaporized hydrogen peroxide is then injected to a vacuum chamber, where articles are decontaminated by exposure to the vaporized hydrogen peroxide. A peristaltic pump is often used to inject an appropriate quantity of liquid hydrogen peroxide to the vaporization chamber. The rate of injection of liquid provided by the peristaltic pump is controlled by modifying the speed of the pump motor.

Proper setting of the injection rate is important to the effective operation of a decontamination system using vaporized hydrogen peroxide. In this regard, the liquid hydrogen peroxide is typically diluted with water to produce a multicomponent liquid. When vaporizing multicomponent liquids, particularly those having components of significantly differing boiling points, the more volatile liquid will vaporize first. In this case, the water vaporizes more quickly than the liquid hydrogen peroxide, and thus the water vapor reaches the items in the vacuum chamber to be disinfected before the hydrogen peroxide vapors, and in higher concentrations. Consequently, the water vapor becomes an effective barrier to hydrogen peroxide penetration around small crevices and lumens of the items in the vacuum chamber.

In view of the aforementioned problem, disinfection systems have been developed that vaporize a multicomponent liquid by injection into a vaporization chamber, wherein successive predetermined increments of the multicomponent liquid are metered at a predetermined rate onto a heated surface of the vaporization chamber. Each liquid increment is substantially instantaneously vaporized before the next succeeding liquid increment is metered onto the heated surface. Accordingly, proper metering of liquid onto the heated surface of the vaporization chamber is important to an effective disinfection operation.

In some prior art injection systems, a direct current (DC) motor is used to drive a peristaltic pump. The injection rate of the pump is a function of the speed of the DC motor. Accordingly, the injection rate is set by adjusting the applied direct current (DC) voltage to the pump motor to a desired parameter, during a factory calibration process. Consequently, the speed of the DC motor is fixed after the factory adjustment. In another prior art injection system, a stepper motor drives a peristaltic pump. The injection rate of the pump is a function of the speed of the stepper motor, and is adjusted during operation of the pump. In this regard, the speed of the stepper motor is adjusted by a motor controller in response to detected changes in the weight of a container filled with liquid hydrogen peroxide for supplying the liquid hydrogen peroxide to the pump. A sensing element provides data to the motor controller indicative of the change in weight of the container, as liquid hydrogen peroxide exit the container.

One problem with prior art injection systems is that there is no feedback indicative of the pump motor speed, and no “real-time” adjustment of the pump motor speed in accordance with a measured pump motor speed. Since the injection rate is a function of the pump motor speed, an undetected mechanical or electrical malfunction causing an improper pump motor speed will also result in an improper injection rate.

The present invention addresses these and other problems with a hydrogen peroxide injection system having a closed-loop flow control.

### SUMMARY OF THE INVENTION

In accordance with the present invention, there is provided a system for controlling the injection rate of liquid hydrogen peroxide supplied to a vaporization chamber in a decontamination system, comprising: (a) a pump for receiving a supply of liquid hydrogen peroxide; (b) a motor for driving the pump, wherein speed of the motor varies in accordance with a speed modulation signal; (c) a motor controller for controlling the speed of the motor by varying the duty cycle of the speed modulation signal; and (d) a motor shaft speed encoder for detecting the speed of the motor, said motor shaft speed encoder transmitting a pulse train to the motor controller indicative of the injection rate of the liquid hydrogen peroxide, wherein said motor controller determines a frequency of the pulse train and modifies the duty cycle of the speed modulation signal in accordance with the determined frequency.

In accordance with another aspect of the present invention, there is provided a method for controlling an injection rate of liquid hydrogen peroxide supplied to a vaporization chamber in a decontamination system, comprising the steps of: (a) detecting speed of a motor driving a pump that supplies liquid hydrogen peroxide to the vaporization chamber, wherein said motor speed is controlled by varying the duty cycle of a speed modulation signal generated by a motor controller; (b) transmitting to the motor controller a pulse train indicative of the injection rate of liquid hydrogen peroxide; (c) determining a frequency of the pulse train; and (d) modifying the duty cycle of the speed modulation signal in accordance with the determined frequency.

An advantage of the present invention is the provision of a hydrogen peroxide injection system that modifies the injection rate of liquid hydrogen peroxide in accordance with real-time data indicative of pump motor speed.

Another advantage of the present invention is the provision of a hydrogen peroxide injection system that provides a feedback control loop for monitoring and adjusting the pump motor speed during operation of the injection system.

Still another advantage of the present invention is the provision of a hydrogen peroxide injection system that uses a low voltage DC motor to drive a peristaltic pump, wherein the pump motor speed may be varied in real-time in response to a motor speed sensor.

A still further advantage of the present invention is the provision of a hydrogen peroxide injection system that provides a low cost means for monitoring and adjusting the pump motor speed during operation of the injection system.

These and other advantages will become apparent from the following description of a preferred embodiment taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a schematic illustration of an exemplary vaporized hydrogen peroxide sterilization apparatus, including a hydrogen peroxide injection system comprised of a peristaltic pump for injection of liquid hydrogen peroxide;

FIG. 2 is a block diagram of the hydrogen peroxide injection system, according to a preferred embodiment of the present invention;

FIG. 3A is a pulse width modulation (PWM) waveform for controlling a pump motor to pump fluid at a first flow rate;

FIG. 3B is a PWM waveform for controlling a pump motor to pump fluid at a reduced flow rate; and

FIG. 3C is a PWM waveform for controlling a pump motor to pump fluid at an increased flow rate.

### DETAILED DESCRIPTION OF A PREFERRED EMBODIMENT

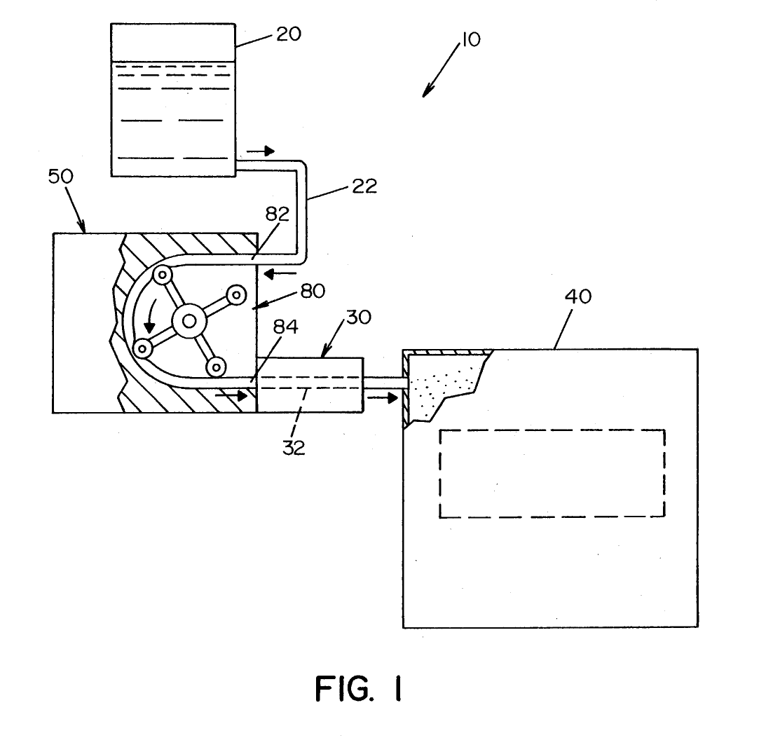

Referring now to the drawings wherein the showings are for the purposes of illustrating a preferred embodiment of the invention only and not for purposes of limiting same, FIG. 1 shows an exemplary vaporized hydrogen peroxide disinfection apparatus 10. Apparatus 10 is generally comprised of a tank 20, a hydrogen peroxide injection system 50, a vaporization chamber 30, and a vacuum chamber 40.

Tank 20 stores liquid hydrogen peroxide that is supplied to injection system 50. The term “liquid hydrogen peroxide” as used herein refers to pure liquid hydrogen peroxide, as well as liquid hydrogen peroxide as a component of a multicomponent liquid. For instance, the liquid hydrogen peroxide may be diluted with water. A conduit 22 connects tank 20 with injection system 50, to provide fluid communication therebetween. Vaporization chamber 30 includes a heated surface 32 for vaporizing the liquid hydrogen peroxide supplied by injection system 50. Heated surface 32 is preferably made of a relatively high thermally conducting material.

Vacuum chamber 40 receives vaporized hydrogen peroxide from vaporization chamber 30. Articles (e.g., medical, pharmaceutical, dental, or mortuary devices, and the like) located inside vacuum chamber 40 are disinfected by exposure to the vaporized hydrogen peroxide.

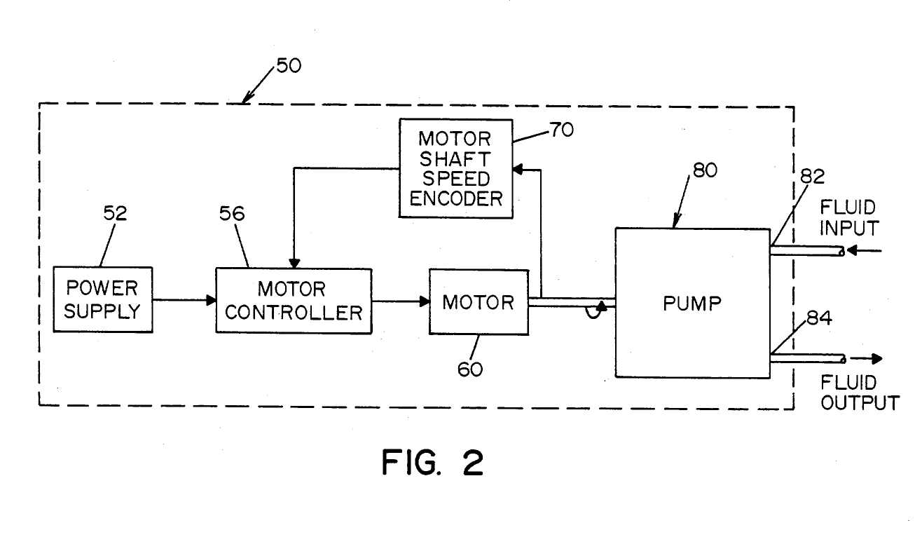

Injection system 50 will now be described in detail with reference to FIG. 2. Injection system 50 is generally comprised of a power supply 52, a motor controller 56, a motor 60, a motor shaft speed encoder 70 and a pump 80. In a preferred embodiment, power supply 52 is a 12 Volt direct current (DC) power supply. Motor controller 56 may take the form of a microcontroller programmed to control the speed of motor 60, as will be explained in detail below. Motor 60 is preferably a low voltage DC motor. Motor shaft speed encoder 70 provides a feedback signal to motor controller 56 indicative of the rotational speed of the shaft of motor 60.

Pump 80 may take the form of a conventional peristaltic pump 80. Peristaltic pump 80 receives liquid hydrogen peroxide from tank 20 at an input port 82. Pump 80 includes rollers that are rotated by motor 60. As the rollers rotate, metered amounts of fluid traveling through the tubing is squeezed through the tubing, and eventually exits through an output port 84. The fluid exiting output port 84 is contacted with heated surface 32 of vaporization chamber 30. The flow rate of fluid exiting pump 80 is determined by the rotational speed of motor 60. The flow rate for peristaltic pump 80 is typically in the range of 1-5 mL/min.

As indicated above, controller 56 controls the speed of motor 60. In a preferred embodiment, controller 56 controls the motor speed by rapidly switching a power transistor on and off, using a technique known as Pulse Width Modulation (PWM). The power transistor acts as a gate to allow a specific amount of current to flow to motor 60. As the transistor is rapidly switched on and off, the amount of current (or average voltage) is dependent upon the ratio between ON time and OFF time of the transistor. This ratio is also referred to as a “duty cycle.” The larger the ratio, the more current that flows to motor 60. The signal generated by switching the transistor is referred to herein as the “speed modulation signal.”

In a preferred embodiment, encoder 70 is an electro-optical position sensor. For instance, encoder 70 may include a glass, mylar, or metal disk with alternating opaque and transparent stripes. Light from an LED or lamp is passed through the disk onto a photosensor that detects the alternating opaque and transparent stripes. Typically, encoder outputs are two-phase digital signals in quadrature (90° out of phase). Rotational direction information is obtained by sensing which output phase is leading.

Encoder 70 also includes electronics used for converting the optical signals to digital signals that are transmitted to controller 56. In this respect, the digital signals take the form of a train of pulses. Controller 56 counts the pulses, and determines the frequency associated with rotation of the motor shaft. In a preferred embodiment, controller 56 accesses a table stored in memory that correlates the measured frequency with the injection rate or “pump speed” of pump 80.

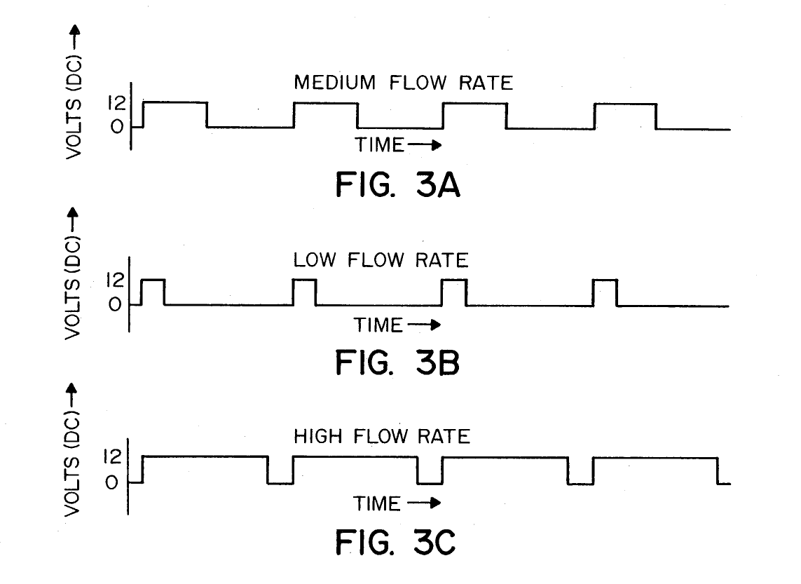

The speed of motor 60 is altered by controller 56 by varying the duty cycle of the speed modulation. In the example, the speed modulation signal is a 12V DC pulse train. FIGS. 3A-3C illustrate speed modulation signals with different duty cycles. The basic frequency of the modulation signal is typically about 400 Hz. Starting with a speed modulation signal as shown in FIG. 3A, if the frequency of the pulse train generated by encoder 70 (i.e., the “encoder frequency”) indicates an injection rate that is too high (i.e., pump 80 is rotating too fast), motor controller 56 reduces the duty cycle of the speed modulation signal by decreasing the width of each pulse (see FIG. 3B). If the encoder frequency indicates an injection rate that is too low (i.e., pump 80 is rotating too slowly), motor controller 56 increases the duty cycle of the speed modulation signal by increasing the width of each pulse (see FIG. 3C).

In a preferred embodiment, motor controller 56 determines whether the injection rate is too low or too high by comparing the encoder frequency to low limit and high limit values, corresponding to a minimum and a maximum injection rate, for proper vaporization in vaporization chamber 30. When controller 56 determines that the encoder frequency is outside the frequency range defined by the low limit and high limit values, controller 56 can take one of several actions, including: (1) increasing the duty cycle of the waveform produced by controller 56, (2) decreasing the duty cycle of the waveform produced by controller 56, or (3) aborting the vaporization processing cycle. The amount of increase or decrease to the duty cycle can be related to the difference between the encoder frequency and the low and high limit values.

In an alternative embodiment, motor controller 56 determines whether the injection rate is too low or too high by accessing a lookup table stored in memory. The lookup table stores an injection rate value corresponding to the encoder frequency. Accordingly, motor controller 56 modifies the duty cycle based upon the determined injection rate value.

For an exemplary peristaltic pump driven by a low voltage DC motor, an encoder frequency of 55 Hz may correspond with an injection rate of 7 grams/minute (of liquid hydrogen peroxide).

Other modifications and alterations will occur to others upon their reading and understanding of the specification. It is intended that all such modifications and alterations be included insofar as they come within the scope of the invention as claimed or the equivalents thereof.

Having described the invention, the following is claimed:

1. A system for controlling the injection rate of liquid hydrogen peroxide supplied to a vaporization chamber in a decontamination system, comprising:
a pump for receiving a supply of liquid hydrogen peroxide;
a motor for driving the pump, wherein speed of the motor varies in accordance with a speed modulation signal;
a motor controller for controlling the speed of the motor by varying the duty cycle of the speed modulation signal; and
a motor shaft speed encoder for detecting the speed of the motor, said motor shaft speed encoder transmitting a pulse train to the motor controller indicative of the injection rate of the liquid hydrogen peroxide, wherein said motor controller determines a frequency of the pulse train and modifies the duty cycle of the speed modulation signal in accordance with the determined frequency.

2. A system according to claim 1, wherein said motor controller includes means for comparing the frequency to predetermined low and high limit values, wherein the low limit value is indicative of a minimum injection rate, and the high limit value is indicative of a maximum injection rate.

3. A system according to claim 2, wherein said motor controller increases the duty cycle of the speed modulation signal, if the frequency is below said low limit value.

4. A system according to claim 1, wherein said motor controller decreases the duty cycle of the speed modulation signal, if the frequency is above said high limit value.

5. A system according to claim 1, wherein said motor controller includes a lookup table for storing injection rate values that correspond to the frequency.

6. A method for controlling an injection rate of liquid hydrogen peroxide supplied to a vaporization chamber in a decontamination system, comprising the steps of:
detecting speed of a motor driving a pump that supplies liquid hydrogen peroxide to the vaporization chamber, wherein said motor speed is controlled by varying the duty cycle of a speed modulation signal generated by a motor controller;
transmitting to the motor controller a pulse train indicative of the injection rate of liquid hydrogen peroxide;
determining a frequency of the pulse train; and
modifying the duty cycle of the speed modulation signal in accordance with the determined frequency.

7. A method according to claim 6, wherein said method further comprises:
comparing the frequency to predetermined low and high limit values, wherein the low limit value is indicative of a minimum injection rate, and the high limit value is indicative of a maximum injection rate.

8. A method according to claim 7, wherein said motor controller increases the duty cycle of the speed modulation signal, if the frequency is below said low limit value.

9. A method according to claim 7, wherein said motor controller decreases the duty cycle of the speed modulation signal, if the frequency is above said high limit value.

10. A method according to claim 7, wherein said step of modifying the duty cycle of the speed modulation signal includes accessing a lookup table storing injection rate values that correspond to the frequency.
